(19) United States
(12) Patent Application Publication
(10) Pub. No.: US 2017/0268707 A1
(43) Pub. Date: Sep. 21, 2017

(54) COUPLING PART FOR A SCREW COUPLING FOR PRESSURE MEDIUM LINES

(71) Applicant: U.M. GEWERBEIMMOBILIEN GMBH & CO. KG, WERDOHL (DE)

(72) Inventors: KLAUS LAUFER, MEINERZHAGEN (DE); FRITZ GEORG WEILAND, MEINERZHAGEN (DE)

(73) Assignee: U.M. GEWERBEIMMOBILIEN GMBH & CO. KG, WERDOHL (DE)

(21) Appl. No.: 15/532,146

(22) PCT Filed: Dec. 8, 2015
(86) PCT No.: PCT/EP2015/078993

§ 371 Date: Jun. 1, 2017

(30) Foreign Application Priority Data
Dec. 8, 2014 (DE) 10 2014 018 073.5

(51) Int. Cl. F16L 29/04; F16L 37/08; F16L 37/33

(52) U.S. Cl. CPC F16L 29/04; F16L 37/33; F16L 37/08

(57) ABSTRACT

A coupling piece, especially a coupling plug, for a screw coupling for pressure medium lines, especially hydraulic lines, for coupling with a corresponding coupling piece, especially a coupling sleeve, in the direction of a coupling axis, having a casing-like coupling housing and a locking casing, especially a locking nut, for locking the coupling piece with the corresponding coupling piece in the coupled setting, wherein the locking casing, has a locking casing thread, especially a locking nut interior thread, for screw connection with a locking counter thread of the corresponding coupling piece, and wherein the locking casing, especially the locking nut in its non-locked setting is mounted in freely turnable fashion on the housing, around the coupling axis, wherein the coupling piece has means by which the locking nut in its locking setting is able to be connected, in an axial direction with the housing so as not to shift or turn.

### CROSS-REFERENCE TO RELATED APPLICATION

This application is a 35 U.S.C. §371 National Phase Application of PCT/EP2015/078993, filed Dec. 8, 2015, which claims the benefit of priority to German Patent Application Serial No.: DE 10 2014 018 073.5, filed Dec. 8, 2014, the contents of which are incorporated herein by reference in their entirety.

### FIELD OF THE INVENTION

The present invention relates to a coupling part, especially a coupling plug, for a screw coupling for pressure medium lines, especially hydraulic lines, as well as a screw coupling with such a coupling part.

### BACKGROUND

Couplings for pressure medium lines are designed as a rule either as plug couplings or screw couplings and ensure quick attachment and separation of two pressure medium lines, especially hydraulic lines. They have two coupling parts able to be connected in the direction of a coupling axis, namely a coupling plug and a coupling sleeve. The coupling plug is able to be inserted into a receptacle of the coupling sleeve and is lockable in a detachable fashion with it. If a screw connection is used for the locking, for example via a locking nut, this is a screw coupling. A plug coupling has a locking ball lock for example as the locking medium. Each coupling part additionally has a coupling housing, within which a spring-loaded closing valve is disposed. In its uncoupled state, the closing valves are so disposed that they close the particular coupling piece or its flow channel. When the two coupling pieces are united, the closing valves automatically open, and upon uncoupling, the valves automatically close by spring force.

One such screw coupling is known, for example, from DE 20 2011 004 778 U1. This has a coupling sleeve and a coupling plug with a plug housing, a casing-like closing valve, a cowl- or bowl-like push rod and a locking nut in the form of a retaining nut. The locking nut is disposed on the exterior around the plug housing and connected so as to turn freely with it about a coupling axis. Additionally, the retaining nut is only subject to limited displaced mounting on the plug housing. For this, the coupling plug has a guard ring. For connection of the two coupling parts, these are inserted into each other. With this, the locking nut is screwed onto an outer threading of the coupling sleeve. What is problematic about this is that, due to vibrations or torque, which are transmitted to the coupling pieces via hydraulic hoses that are attached to one or both of the coupling pieces, the locking nuts can get loose in an undesired fashion. One coupling part, as a rule the coupling sleeve, is usually attached in fixed fashion to the machine, the second coupling part is attached via a hydraulic hose to the working device (such as a drilling device or hammer). During operation, the working device moves relative to the machine. The hydraulic hoses are sufficiently flexible to accommodate these motions, but also sufficiently rigid that substantial radial and axial forces as well as torque can be transmitted to the coupling site.

With reference to FIG. 3 which depicts the prior art, so that the locking nut 100 cannot get unintentionally loose, with one known screw coupling 101 it is customary to provide a splint 102 between the coupling sleeve 103 and locking nut 100. This is disposed on the coupling-side end of locking nut 100. The splint prevents locking nut 100 from twisting, but only if locking nut 100 has already minimally turned and it securely adjoins the groove shoulder of coupling sleeve 103. What is disadvantageous with this is that then nearly all of the axial force is assumed by splint 102 and the groove shoulder, and therefore it can work itself into the material of locking nut 100 and/or coupling sleeve 103. For example, as already explained, it is possible that exterior forces, sometimes high-level ones, can act on the attached pressure medium lines, which twist them against each other. If the forces are too great, splint 102 works itself into the material of locking nut 100 and/or coupling sleeve 103, until the thread flanks again come into contact and can transfer axial forces. This process of minimal loosening of locking nut 100 with subsequent working in of splint 102 can be permanently repeated and can destroy coupling 101. As a consequence, splint 102 is not suitable for applications in which vibrations appear in connection with torques that act from outside on a coupling part.

The task of the present invention is to make available a coupling part that can be manufactured in a cost-effective fashion, especially a coupling plug, for a screw coupling for pressure medium lines, especially hydraulic lines, which ensures a simple and safe, durable connection with the other coupling part, especially a coupling sleeve.

An additional task is to provide a screw coupling with such a coupling piece.

These tasks are solved by a coupling piece and a screw coupling in accordance with embodiments described herein.

### BRIEF DESCRIPTION OF THE DRAWINGS

In what follows the invention is explained in greater detail by example using drawings. Shown are:

FIG. 1: is a side view, half cut away, of an embodiment of a screw coupling with a coupling sleeve and a coupling plug in accordance with this invention shown in a plugged-together or coupled and locked state

FIG. 2: is a side view, half cut away, of coupling plug in accordance with the present invention in its uncoupled state

FIG. 3: is a partially cut-away side view of a coupled and locked screw coupling as per the prior art.

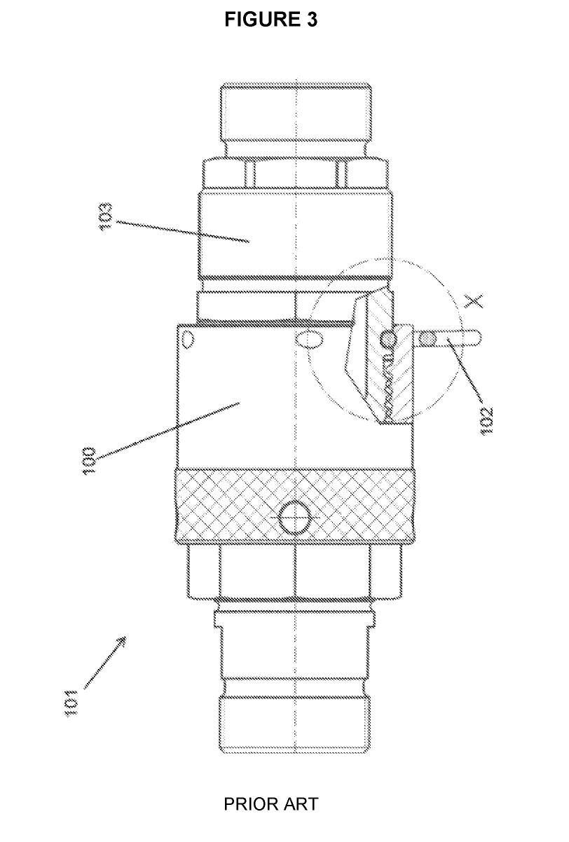

### DETAILED DESCRIPTION

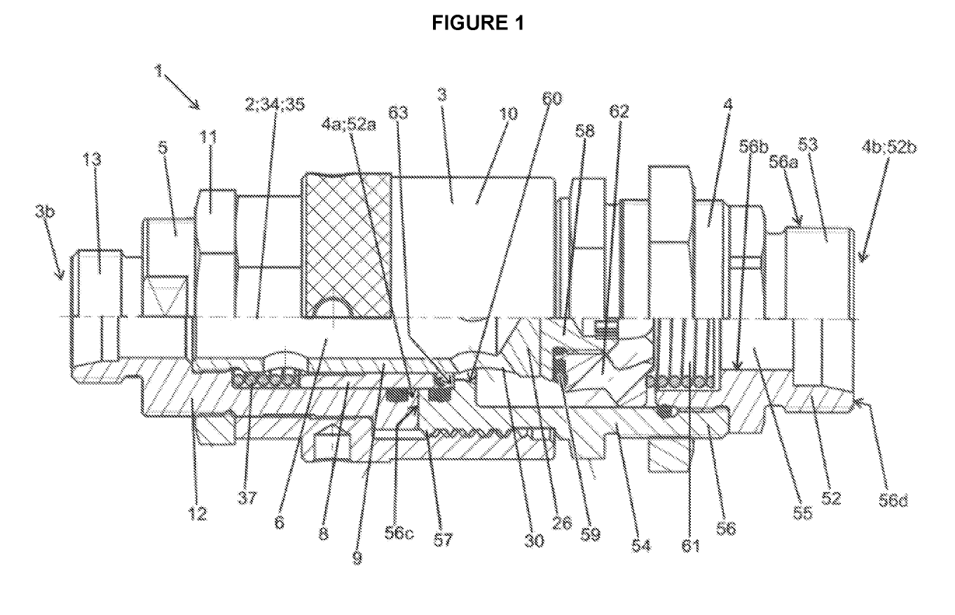

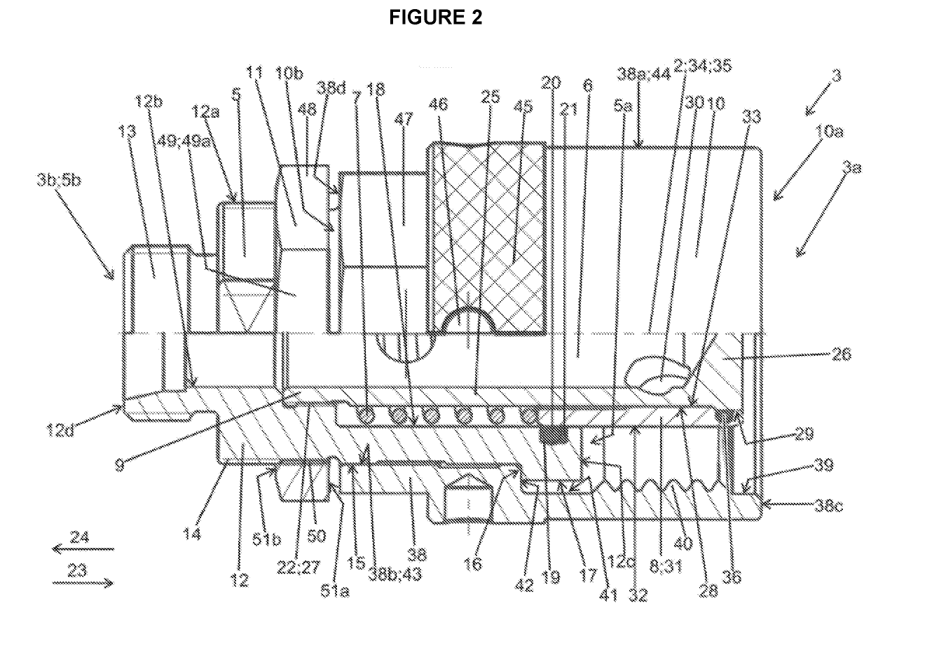

The screw coupling 1 in accordance with this invention is shown by FIGS. 1 and 2 and has two coupling parts 3;4 that correspond to and are complementary to each other, and are able to be connected in the direction of a coupling axis or plugging axis 2, namely an invention-specific coupling plug 3 and a coupling sleeve 4. Customarily coupling plug 3 is disposed on the side of a consumer or aggregate (receiver side) and coupling sleeve 4 is disposed on the side of a pressure medium pump, especially a hydraulic pump (donor or supply side). For certain applications in which a residual pressure also exists in the hydraulic system on the donor side, coupling plug 3 can also be disposed on the donor side.

The invention-specific coupling plug 3 and coupling sleeve 4 each have a respective coupling end 3a;4a and an attachment or line end 3b; 4b, with the two ends 3a;3b and 4a;4b of the particular coupling piece 3,4 lying opposite in the direction of coupling axis 2. At coupling end 3a;4a, coupling plug 3 and coupling sleeve 4 are united. At attachment end 3b;4b, coupling plug 3 and coupling sleeve 4 are connected with the particular pressure medium line (not shown), especially a hydraulic line, preferably a pipe or a hose.

The terms “axial,” “radial,” and “in the circumferential direction,” as used in what follows, always relate to coupling axis 2, if nothing to the contrary is mentioned. The designation “circular cylindrical” likewise relates to coupling axis 2 as a rotational or central axis.

According to a preferred embodiment, the present invention especially relates to coupling plug 3, therefore this is described initially in what follows:

The invention-specific coupling plug 3 shown by FIGS. 1 and 2 has a plug housing 5, a passage or flow channel 6 for the pressure medium, especially the hydraulic medium, a valve seal with a closing spring 7, and a casing-like plug closing valve 8, a cuplike push rod 9, a locking casing, especially a locking nut 10, and according to the invention a counter or lock nut 11 for countering locking nut 10 in its locked setting.

Casing-like plug housing 5 preferably consists of metal, especially free-cutting (machine) steel, heat-treatable steel or nitriding steel. It has a coupling-side housing end 5a and an attachment or line-side housing end 5b. In addition, plug housing 5 has a housing wall 12 with a wall outer surface 12a and a wall inner surface 12b. Housing wall 12 also has a coupling-side wall front surface 12c and a line-side wall front surface 12d. On line-side housing end 5b, the plug housing 5 has an attachment socket 13 with an exterior thread for attachment to a pressure medium line, especially a hydraulic line. Naturally, instead of the exterior thread other connections may be present, such as interior threads or flange connections.

The exterior wall surface 12a of housing wall 12 has an outer thread 14, viewed in the direction of coupling axis 2 from the attachment-side housing end 5b toward coupling-side housing end 5a, in connection to the attachment sleeve 13, to admit counter nut 11. Outer thread 14 has a greater diameter than the outer thread of attachment sleeve 13. Adjoining outer thread 14 is a circular-cylindrical locking nut support surface 15, which serves for rotatable mounting of locking nut 10 about coupling axis 2. Locking nut support surface 15 preferably has a diameter that matches that of the exterior diameter of outer thread 14. Preferably locking nut support surface 15 has an annular groove that encircles and extends radially outward, which serves for reducing friction. Adjoining locking nut mounting surface 15 is an annular locking nut counter mounting surface 16, which preferably is perpendicular to coupling axis 2. Locking nut counter mounting surface 16 extends, as viewed in the radial direction, outward from locking nut mounting surface 15. At locking nut counter mounting surface 16, preferably a surface 17 adjoins, preferably one that is in particular circular-cylindrical, the diameter of which is greater than the diameter of locking nut mounting surface 15. This surface 17 preferably adjoins the coupling-side wall front surface 12c.

In a manner known per se, interior wall surface 12b of housing wall 12 has a circular-cylindrical valve guidance surface 18, which serves for gliding guidance of plug closing valve 8. In the area of valve guidance surface 8, additionally a gasket receiving groove 19 is present that rebounds radially outward relative to valve guidance surface 18. In gasket receiving groove 19, a first valve gasket 20 and preferably a supporting ring 21 are disposed. Gasket receiving groove 19 is disposed on the coupling-side housing end 5a.

In addition, wall inner surface 12b of housing wall 12 has an interior thread 22, which serves for screwing in of push rod 9, which is described in what follows in greater detail:

The cup-shaped or cowl-shaped push rod 9, known per se, has a pipe-shaped rod wall 25 and a rod head 26. The rod head 26 is disposed on a rod end on the coupling side. On the outer side, rod wall 25, as viewed from an attachment-side rod end toward the coupling-side rod end, has first an exterior thread 27. Adjoining that is a circular-cylindrical valve guidance surface 28, which makes a transition via a conical radially expanding valve support surface into a circular-cylindrical valve seat surface 29. In addition, the rod wall 25 has multiple through-running flow openings 30.

Push rod 9 is disposed within plug housing 5 and is connected securely with it, thus unable to be displaced or turned. For this, push rod 9 with its outer thread 27 is screwed into interior thread 22 of plug housing 5. With this, the push rod with its attachment-side rod end, and especially with its rod head 26, projects in an axial direction out of plug housing 5. The flow channel 6 of coupling plug 3 is partially bordered by plug housing 5 and partially by push rod 9 in a manner known per se.

The casing-like plug locking valve 8 which is known per se has a pipe like valve wall 31. On the outer side, valve wall 31 has a through-running, circular-cylindrical valve glide and sealing surface 32. On the inner side, valve wall 31, as viewed from an attachment-side valve end toward a coupling-side valve end, has a circular-cylindrical valve glide surface 33, a conical valve stop surface that expands radially, and a circumferential annular gasket admission groove. In the gasket admission groove are disposed a second valve gasket 36 and preferably a second support ring.

The plug closing valve 8 is disposed about push rod 9. With this, with its valve glide surface 33, it is mounted so as to glide back and forth in an axial direction on the valve guidance surface 28 of push rod 9. With this, closing spring 7 forces plug closing valve 8 into its closed position in a valve closing setting 23 parallel to coupling axis 2. For opening, the plug closing valve 8 is moved against the force of closing spring 7 in an opposing valve opening direction 24. In the closed position, the second valve gasket 36 adjoins and seals valve seat surface 29 of push rod 9. The first valve gasket 20 always adjoins valve gliding and sealing surface 32 so it can glide. Plug closing valve 8 is able to move back and forth in the axial direction on valve gasket 20 with the valve gliding and sealing surface 32 and thus is mounted in plug housing 5.

The invention-specific locking nut 10 likewise preferably consists of metal, especially of free-cutting (machine) steel or nitriding steel. In addition, locking nut 10 has a locking nut end 10a on the coupling side and a locking nut end 10b on the attachment side. In addition, locking nut 10 has a pipe-shaped locking nut wall 38 with a wall outer surface 38a and a wall inner surface 38b, as well as a wall front surface 38c on the coupling side and a wall front surface 38d on the attachment side.

Interior wall surface 38b of locking nut wall 38, as viewed from locking nut end 10a on the coupling side toward locking nut end 10b on the attachment side, first has a circular-cylindrical surface 39. Adjoining surface 39 is a locking nut interior thread 40. The reset locking nut interior thread 40 is protected against damage by surface 39. Locking nut 10 has a locking nut screw-in axis 34, which is coaxial to coupling axis 2. The locking nut interior thread 40 is preferably a right-handed thread. Preferably in addition, locking nut interior thread 40 is a round thread. This can however also be another type of thread, preferably a metric thread or a trapezoidal thread.

Adjoining locking nut interior thread 40 is a thread relief groove 41. The diameter of thread relief groove 41 is greater than or equal to the core diameter (interior diameter) of locking nut interior thread 40. Adjoining thread relief groove 41 is an annular locking nut stop surface 42, which preferably is perpendicular to coupling axis 2. Locking nut stop surface 42 extends radially inward from thread relief groove 41. Adjoining locking nut stop surface 42 is a circular-cylindrical locking nut gliding surface 43. The diameter of locking nut gliding surface 43 is less than the diameter of thread relief groove 41. Locking nut gliding surface 43 preferably has an encircling annular groove that extends radially outward, which serves for reducing friction. Locking nut gliding surface 43 extends out to the locking nut end 10b on the attachment side and, on it, preferably makes a transition into the wall front surface 38d on the attachment side.

As viewed from the locking nut end 10a on the coupling side toward locking nut end 10b on the attachment side, wall exterior surface 38a of locking nut wall 38 first has a smooth outer wall section 44, preferably a circular cylindrical one. Adjoining this is a knurled outer wall section 45. In the area of knurled outer wall section 45, preferably there are multiple blind boreholes 46 extending into locking nut wall 38, which serve for engagement of an installation tool. Other means to make engagement with an installation tool are also possible. Adjoining knurled outer wall section 45 is an exterior hexagonal surface 47. This extends to the locking nut end 10b on the attachment side and preferably makes a transition on it into wall front surface 38d on the attachment side.

On the outer side, locking nut 10 is disposed about plug housing 5 and is mounted so as to freely turn in its uncountered and especially unlocked setting about coupling axis 2. For this, locking nut 10 with its locking nut gliding surface 43 is mounted so as to freely turn on locking nut mounting surface 16 of plug housing 5. In addition, locking nut stop surface 42 of locking nut 10 is disposed in the axial direction to be in alignment or to adjoin locking nut counter mounting surface 16 of plug housing 5. Therefore, locking nut counter mounting surface 16 serves as a support for the motion of locking nut 10 on plug housing 5 in the direction 23 of valve closing. In the direction 24 of valve opening, the motion of locking nut 10 on plug housing 5 is limited by the invention-specific counter-nut 11:

Likewise the invention-specific counter-nut 11 consists of metal, especially of free-cutting (machine) steel or nitriding steel. In addition, counter-nut 11 has an annular counter-nut wall 48 with an outer drive profile 49, especially an outer hexagonal profile 49a, for driving with a tool and/or for manual driving, as well as with a counter-nut interior thread 50. However, the outer drive profile 49 can be otherwise configured, for example, it can have two key faces or it can be generally configured as an exterior polygonal profile, for example as an exterior octagonal profile, or it can have recesses for Allen wrenches or knurled surfaces for manual operation. In addition, counter-nut 11, especially the counter-nut wall 48, has a counter-nut front or adjoining surface 51a on the coupling side and a counter-nut front or adjoining surface 51b on the attachment side. The two counter-nut front surfaces 51a;b are preferably perpendicular to coupling axis 2.

In especially preferred fashion, counter-nut interior thread 50 is configured to be opposite to locking nut inner thread 40. This means that counter-nut interior thread 50 is preferably a left-handed thread. Preferably, counter-nut interior thread 50 has a smaller pitch than locking-nut interior thread 40. By means of the smaller pitch, with the same torque, a stronger clamping of the locking nut 10 is achieved between plug housing 5 and counter-nut 11.

Counter-nut 11 is likewise disposed on the outer side around plug housing 5. With counter-nut interior thread 50, counter-nut 11 is screwed onto the outer thread 14 of housing wall 12 that is complementary to it and corresponds to it. With this, a counter-nut screwing axis 35 of the counter-nut is coaxial to locking nut screwing axis 34. With this, the counter-nut front surface 51a on the coupling side is in axial alignment with and directly adjoins wall front surface 38d of locking nut 10 on the attachment side. By this means, counter-nut 11 serves as a support for the motion of locking nut 10 on plug housing 5 in valve opening direction 24. However, in the state of coupling plug 3 where it is uncoupled and not locked, counter-nut front surface 51a is at a distance from wall front surface 38d of locking nut 10 on the attachment side. By this means, locking nut 10 in its setting that is not locked and not countered, is freely rotatable.

Before the coupling and locking process is described in greater detail, a brief description will be given of the coupling sleeve 4, referring to FIG. 1.

Coupling sleeve 4 has a sleeve housing 52, which preferably consists of two sleeve housing pieces that are securely but detachably connected to each other, especially an attachment piece 53 for attachment of a pressure medium line, especially a hydraulic line, and a sleeve base body 54. In addition on the coupling side, sleeve housing 52 has a housing end 52a facing toward plug housing 3 and a housing end 52b facing the attachment or line side. Likewise, sleeve housing 52 acts as a boundary for a flow channel 55. In addition, sleeve housing 52 has a housing wall 56 with a wall outer surface 56a, a wall inner surface 56b, a wall front surface 56c on the coupling side and a wall front surface 56d on the attachment side. On housing end 52a on the coupling side, wall outer surface 56a has a locking counter thread 57 corresponding to the locking nut inner thread 40 in the form of an exterior thread.

In addition, coupling sleeve 4 has a sleeve closing valve 58 that closes flow channel 55 in its uncoupled state, and is axially displaceable. For example, sleeve closing valve 58 is configured in two parts and has a valve gasket 59, especially one that is comb like, which in an uncoupled state adjoins a conical valve seat surface 60 of coupling sleeve 4 in sealing fashion. However, the valve seal of coupling sleeve 4 can have another design, for example as a flat seal (not depicted). For driving sleeve closing valve 58 into its closing setting, a closing spring 61 is provided. In addition, sleeve closing valve 58 likewise has through flow passages 62.

In joining, especially pushing together or screwing together the two coupling pieces 3;4 parallel to coupling axis 2, the rod head 26 compresses sleeve closing valve 58 into its open setting, in which it is lifted off valve seat surface 60. By this means, flow channel 55 of coupling sleeve 4 is opened. When coupling together the sleeve closing valve 58, push rod 9 consequently drives sleeve closing valve 58 relative to sleeve housing 52 so that flow channel 55 is automatically opened.

In addition a drive surface 63 of sleeve housing 52 compresses plug closing valve 8 into its opened setting, in which the second valve gasket 36 no longer adjoins valve seat surface 29 and the flow openings 30 are free. By this means, flow channel 6 of coupling plug 3 is opened. Upon joining, sleeve housing 52 consequently moves plug closing valve 8 relative to plug housing 5 and to push rod 9 in the direction 24 of valve opening, so that flow channel 6 is automatically opened. Thus the two flow channels 6;55 are connected in flow terms, especially hydraulically.

The two coupling pieces 3;4 as a rule are slid together with the aid of locking nut 10. For joining, these with their locking nut interior thread 40 are screwed onto locking counter thread 57 of coupling sleeve 4. With this, locking nut 10 turns freely on plug housing 5. Due to the screwing on, the two coupling pieces 3;4 are drawn together by means of the two threads 40;57. The two coupling pieces 3;4 are drawn together in this, until the two wall front surfaces 12c;52c on the coupling side touch each other. As shown in FIG. 1, the locking nut stop surface 42 of locking nut 10 then adjoins locking nut counter surface 16 of plug housing 5. By means of locking nut 10, the two coupling pieces 3;4 are now detachable locked to each other in a manner known per se.

To prevent this locking from becoming loose in operation, for example due to vibration, the invention-specific counter-nut 11 is present. This is screwed on from the housing end 5b of plug housing 5 on the attachment side onto the exterior thread 14 until the counter-nut front surface 51a on the coupling side adjoins wall front surface 38d of locking nut 10 on the attachment side. Since the counter-nut interior thread 50 of counter-nut 11 is opposed to locking nut interior thread 40, locking nut 10 is securely countered by means of counter-nut 11. Thus, locking nut 10 can no longer be turned and in operation it cannot get loose in undesired fashion. In its countered setting it is connected securely, thus unrotatably and undisplaceably, with plug housing 5. Locking nut 10 is held in clamped fashion between counter-nut front surface 51a on the coupling side and locking nut counter mounting surface 16 of plug housing 5.

Only after deliberate loosening of counter-nut 11, can locking nut 10 again be freely turned and the two coupling pieces 3;4 be detached from each other. If the two coupling pieces 3;4 are again screwed apart from each other, the two closing valves 8;58 automatically move in the reverse direction, into their initial setting. The locking springs 7;61 automatically provide the drive.

The advantage of the invention-specific counter-nut 11 is that high axial forces can be admitted without the components of the invention-specific screw coupling being damaged or failing.

In addition, the two coupling pieces 3;4 can be twisted against each other with very high torques in the opening direction without them being damaged thereby. For because the connection between coupling plug 3 and coupling sleeve 4 is minimally loosened when exterior torques appear, the coupling is not torque-loaded. In some applications, the turning motion is even desired.

However, the hose end cannot turn permanently in one direction, because also the other hose end does not permanently turn, but rather always only by a relatively small turning angle. Therefore, with the invention-specific solution with counter-nut 11, in fact the locking nuts 10 do turn slightly vis-à-vis coupling sleeve 4, but do not become completely loose. In contrast, with the prior art without the splint, the locking nuts turn piece by piece about the plug housing and in an extreme case, become completely uncoupled. In the prior art with the splint, the locking nuts can always turn until fixed contact of the splint, and the already described effect occurs.

With the invention-specific solution it is in addition also possible to unite the two coupling pieces 3;4 and lock them with each other so that they are at a slight distance from each other in the axial direction, such as by about 1 mm. This for example is advantageous if, with the particular application, via turning of the hydraulic hose, very high torque is applied with a small turning angle. The arrangement at a distance also avoids the coupling pieces 3;4 or the hose connection being damaged by torsion in the closing direction during slight turning.

It is also naturally within the scope of the invention that the counter-nut 11 has no opposing thread, even if this is preferred.

In addition it is within the scope of the invention that in place of counter-nut 11, a counter-screw (not depicted) is present, which for example is configured as a hollow screw and, with its counter-screw exterior thread, being screwed into an interior thread of the coupling plug. In this case also the locking nut 10 is held in clamped fashion between the counter-screw and a support fixed in the housing. However, counter-nut 11 is preferred.

Also, instead of the preferred locking nut 10, a locking casing with a locking casing interior thread can be provided. The locking casing is then screwed with a corresponding exterior thread as a locking counter-thread during coupling.

In addition, according to the invention, other means are conceivable, by which the locking nut can be connected in its locking setting in fixed fashion, thus in non-rotatable and non-displaceable fashion, directly with plug housing 5, preferably clamped or by means of clamping. These means are part of the coupling plug, not of the coupling sleeve. Or, the connection is directly between the coupling plug and the locking casing without intermediate placement of the coupling sleeve.

While the above description constitutes the preferred embodiment of the present invention, it will be appreciated that the invention is susceptible to modification, variation, and change without departing from the proper scope and fair meaning of the accompanying claims.

1. A first coupling piece for a screw coupling for pressure medium lines, including hydraulic lines, for coupling with a corresponding second coupling piece, in the direction of a coupling axis, the first coupling piece comprising,
a casing-like coupling housing and a locking casing, for locking the first coupling piece with the corresponding second coupling piece in a coupled condition, wherein the locking casing has a locking casing thread for a screw connection with a locking counter thread of the corresponding second coupling piece, and wherein the locking casing in a non-locked setting is mounted in freely turnable fashion on the coupling housing, around the coupling axis, wherein the first coupling piece has means by which the locking casing in a locking setting is able to be connected in an axial direction with the housing so as not to shift and not to turn,
the first coupling piece further having a counter-nut or counter-screw screwed onto the coupling housing for countering the locking casing in the locking setting.

2. The first coupling piece according to claim 1, further comprising,
the locking casing in a countered setting by the counter-nut or the counter-screw is countered in such a way that the locking casing is connected in an axial direction with the coupling housing so as not to shift and not to turn.

3. The first coupling piece according to claim 1, further comprising,
the counter-nut has a counter-nut interior thread or the counter-screw has a counter-screw exterior thread, wherein the counter-nut interior thread or the counter-screw exterior thread is counter to the locking casing thread.

4. The first coupling piece according to claim 1, further comprising,
the counter-nut has a counter-nut interior thread, which is counter to the locking thread of the locking casing.

5. The first coupling piece according to claim 4, further comprising,
the counter-nut interior thread or the counter-screw exterior thread has a lesser pitch than the locking casing thread of the locking casing.

6. The first coupling piece according to claim 1, further comprising,
a locking nut screwing axis of the locking nut and a counter-nut screwing axis of the counter-nut are coaxial to each other and coaxial to the coupling axis.

7. The first coupling piece according to claim 1, further comprising,
the first coupling piece has a coupling end and an attachment or line end and the coupling housing has a coupling-side housing end and an attachment-side housing end.

8. The first coupling piece according to claim 1, further comprising,
the locking casing, in its countered setting is held so as to clamp between the counter-nut or the counter-screw and a support that is connected with the housing or is housing-fixed.

9. The first coupling piece according claim 1, further comprising,
the counter-nut is disposed in the axial direction adjoining to the locking casing, especially adjoining to an attachment-side locking casing end of the locking casing.

10. The first coupling piece according to claim 7, further comprising,
the coupling housing has a housing wall with a wall outer surface, a wall inner surface, a coupling-side wall front surface and an attachment-side wall front surface.

11. The first coupling piece according to claim 1, further comprising,
wherein the locking casing is a locking nut, the wall outer surface has an exterior thread, on which the counter-nut is screwed, and a circular-cylindrical locking nut mounting surface, on which the locking nut is mounted so as to glide, wherein the exterior thread and the circular-cylindrical locking nut mounting surface are disposed adjoining each other in the axial direction and or the exterior thread is disposed in relation to the locking nut mounting surface on the attachment side.

12. The first coupling piece according to claim 11, further comprising,
axially opposite to exterior thread, the locking nut mounting surface is adjoined by an annular locking nut support surface, which is perpendicular to the coupling axis, wherein the locking nut support surface, as viewed in the radial direction, extends outward from the locking nut mounting surface.

13. The first coupling piece according to claim 7, further comprising,
the locking casing being a locking nut, the locking nut has a tubular locking nut wall with a wall outer surface, a wall inner surface, and a coupling-side wall front surface and an attachment-side wall front surface.

14. The first coupling piece according to claim 13, further comprising,
the wall inner surface of locking nut wall, as viewed from the coupling-side locking nut end toward an attachment-side locking nut end, has, disposed consecutively, the locking nut interior thread, an annular locking nut stop surface, and a circular-cylindrical locking nut glide surface.

15. The first coupling piece according to claim 1, further comprising,
the locking casing is a locking nut that is disposed on the exterior side about the housing, and on it, in the non-countered setting, is freely mounted to slide and turn about the coupling axis.

16. The first coupling piece according to claim 15, further comprising,
the locking nut in its non-countered setting is mounted in freely turnable fashion with its locking nut gliding surface on the locking nut mounting surface of the coupling housing.

17. The first coupling piece according to claim 15, further comprising,
the locking nut stop surface of the locking nut is disposed in the axial direction adjoining to the locking nut support surface of the coupling housing, so that the locking nut is disposed in the axial direction between the locking nut support surface of the coupling housing and the counter-nut.

18. The first coupling piece according to claim 17, further comprising,
the locking nut in its countered setting of the locking nut support surface of the coupling housing and the counter-nut is held in clamping fashion.

19. The first coupling piece according to claim 1, further comprising,
the first coupling piece has a valve seal with a closing valve able to be shifted back and forth in the axial direction within the flow channel for closing the flow channel in an uncoupled state of the coupling piece.

20. The first coupling piece according to claim 1, further comprising,
the first coupling piece is a coupling plug.

21. A screw coupling for pressure medium lines, including hydraulic lines, wherein the first and second coupling pieces are able to be detachably locked with each other, further comprising,
the first coupling piece is configured according to claim 1, and the second coupling piece has the locking counter thread.

22. The screw coupling according to claim 21, further comprising,
in a coupled and locked setting of the first and second coupling pieces, the locking casing with its locking thread is screwed with the locking counter thread, of the locking nut with its locking nut interior thread onto the locking counter thread.

23. The screw coupling according to claim 21, further comprising,
the first and second coupling pieces each have a coupling housing with a flow channel and a closing valve disposed within the flow channel for closing the flow channel in the uncoupled state of the coupling, wherein preferably the two closing valves upon coupling the first and second coupling pieces are automatically opened.

24. The first coupling piece according to claim 1, wherein the locking casing is a locking nut, and wherein the locking thread is a locking nut interior thread.

25. The first coupling piece according to claim 1, wherein the second coupling piece is a coupling sleeve.

26. The first coupling piece according to claim 1, wherein the locking casing in a locking setting is able to be connected, by clamping in an axial direction with the housing so as not to shift and not to turn.
